(19) United States
(12) Patent Application Publication
(10) Pub. No.: US 2006/0192775 A1
(43) Pub. Date: Aug. 31, 2006

(54) Using detected visual cues to change computer system operating states

(75) Inventors: Clark D. Nicholson, Seattle, WA (US); Zhengyou Zhang, Bellevue, WA (US); Pasquale DeMaio, Bellevue, WA (US)

Correspondence Address: LAW OFFICES OF ALBERT S. MICHALIK;C/O MICROSOFT CORPORATION, 704 - 228TH AVENUE NE, SUITE 193, SAMMAMISH, WA, 98074, US

(73) Assignee: Microsoft Corporation, Redmond, WA (US)

(21) Appl. No.: 11/066,988

(22) Filed: Feb. 25, 2005

(51) Int. Cl. G09G 5/00

(52) U.S. Cl. 345/211

(57) ABSTRACT

Described is a method and system that uses visual cues from a computer camera (e.g., webcam) based on presence detection, pose detection and/or gaze detection, to improve a user's computing experience. For example, by determining whether a user is looking at the display or not, better power management is achieved, such as by reducing power consumed by the display when the user is not looking. Voice recognition such as for command and control may be turned on and off based on where the use is looking when speaking. Visual cues may be used alone or in conjunction with other criteria, such as mouse or keyboard input, the current operating context and possibly other data, to make an operating state decision. Interaction detection is improved by determining when the user is interacting by viewing the display, even when not physically interacting via an input device.

### FIELD OF THE INVENTION

The invention relates generally to computer systems, and more particularly to controlling computer systems that have connected cameras.

### BACKGROUND OF THE INVENTION

The use of cameras with a personal computer system (computer cameras) is becoming commonplace. Such computer cameras, often referred to as “webcams” because many users use computer cameras for sending live video over the web, may be built into a personal computer, or may be added later, such as via a USB (universal serial bus) connection. Add-on computer cameras may be positioned on small stands, but are typically clipped to the user's monitor.

Computer cameras may be used in conjunction with software for face-tracking, in which the camera can adjust itself to essentially follow around a user's face. For example, face detection is described in U.S. patent application Ser. No. 10/621,260 filed Jul. 16, 2003, entitled “Robust Multi-View Face Detection Methods and Apparatuses.” Moreover, U.S. patent application Ser. No. 10/154,892 filed May 23, 2002, entitled “Head Pose Tracking System,” describes a mechanism by which not only may a user's face be tracked, but parallax is adjusted using mathematical correction techniques so that when a user having a video conference looks at a display monitor to view others' images, the appearance is that of the user looking into the camera rather than looking down (typically) at the monitor. This reduction in parallax provides a better user experience, because among other reasons, the appearance of looking down or away (even though actually looking at them in the display) from people during a conversation has many negative connotations, whereas maintaining eye contact has positive connotations. These patents are assigned to the assignee of the present invention and hereby incorporated by reference.

Other software is being improved for the purposes of performing pose detection, which is directed towards determining a user's general viewing direction, e.g., whether a user is generally looking at a computer camera (or some other fixed point), or is looking elsewhere. Gaze detection, another evolving technology, is generally directed towards determining more precisely where a user is looking among variable locations, e.g., at what part of a display.

While software is thus evolving to improve users' experiences and interactions with cameras, there are a number of non-camera related computing tasks and problems that could be improved by the visual detection capabilities of a computer camera and presence detection, pose detection and/or gaze detection software. What is needed is a set of software-based mechanisms that leverage the visual detection capabilities of a computer camera to improve a user's overall computing experience.

### SUMMARY OF THE INVENTION

Briefly, the present invention provides a system and method that uses one or more computer cameras, along with visual cues based on presence detection, pose detection and/or gaze detection software, to improve a user's overall computing experience with respect to performing a number of non-camera related computing tasks. To this end, by detecting via visual cues as to whether and/or where a user is looking at a point such as a display monitor, one or more computer operating states may be changed to accomplish non-camera related computing tasks. Examples include better management of power consumption by reducing power when the user is not looking at the display, turning voice recognition on and off based on where the user is looking, faster-perceived startup by resuming from lower-power states based on user presence, different application program behavior, and other improvements. Visual cues may be used alone or in conjunction with other criteria, such as the current operating context and possibly other sensed data. For example, the time of day may be a factor in sensing motion, possibly including turning the camera on (which may be turned off after some time with no motion sensed) to again look for motion, such as to wake a computer system into a higher-powered state in anticipation of usage as soon as motion is sensed at the start of a workday.

In one example implementation, pose tracking may be used to control power consumption of a computer system, which is particularly beneficial for mobile computers running on battery power. In general, while presence detection may be used to turn the computer system's display on or off to save power, more specific visual cues such as pose detection can turn the display off or otherwise reduce its power consumption when the user is present, but not looking at the display. Other power-consuming resources such as processor, hard disk, and so on may be likewise controlled based on the current orientation of the user's face.

Similarly, one of the most significant challenges to speech recognition is determining, without manual input or specific verbal cues, when the user is intending to speak to the computer system/device, as opposed to otherwise just talking. To solve this challenge, the present invention employs visual cues, possibly in conjunction with other data, to determine when the person is likely intending to communicate with the computer or device (versus directing speech elsewhere). More particularly, by knowing via visual cues the direction a person is looking when he or she speaks, e.g., generally towards the display monitor or not, a mechanism running on a computer can determine if the user is likely intending to control the computer via voice commands or is directing the speech elsewhere.

In one implementation, pose detection which may be trained determines whether the user is considered as generally looking towards a certain point, typically the computer system's display. With this information, an architecture such as incorporated into the computer's operating system utilizes the camera to process images of the user's face to obtain visual cues, by analyzing the user's face and the orientation of the face relative to display, as well as possibly obtain other information, such as by detecting key presses, mouse movements and/or speech. This information may be used by various logic to determine whether a user is interacting with a computer system, and thereby decide actions to take, including power management and speech handling.

Other advantages will become apparent from the following detailed description when taken in conjunction with the drawings, in which: BRIEF DESCRIPTION OF THE DRAWINGS

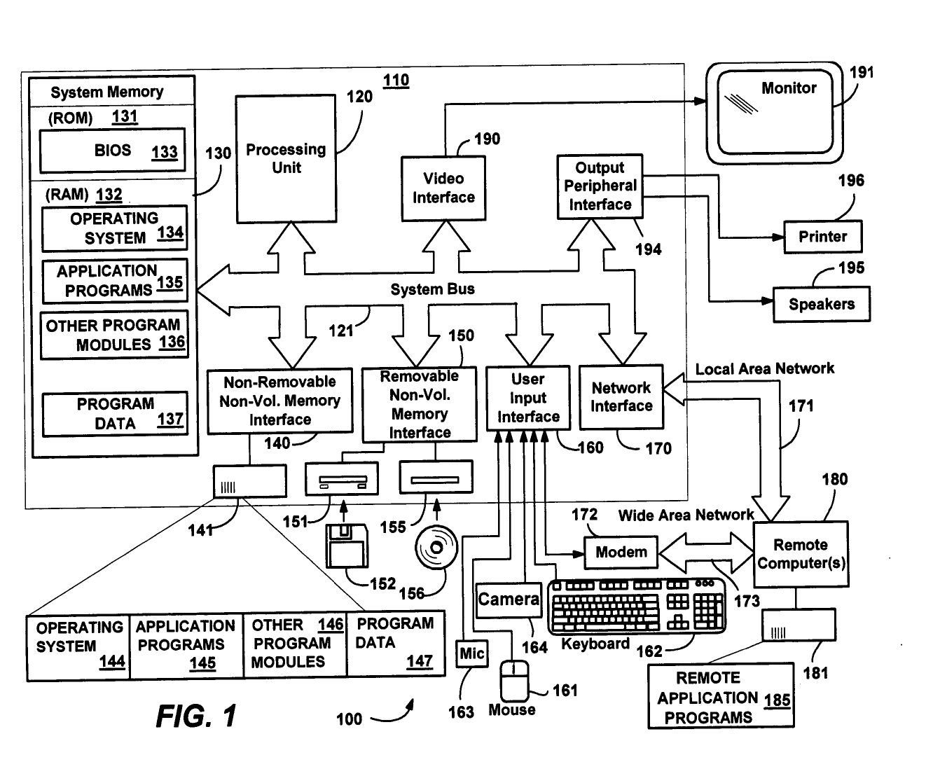

FIG. 1 is a block diagram representing a general purpose computing device in the form of a personal computer system into which the present invention may be incorporated;

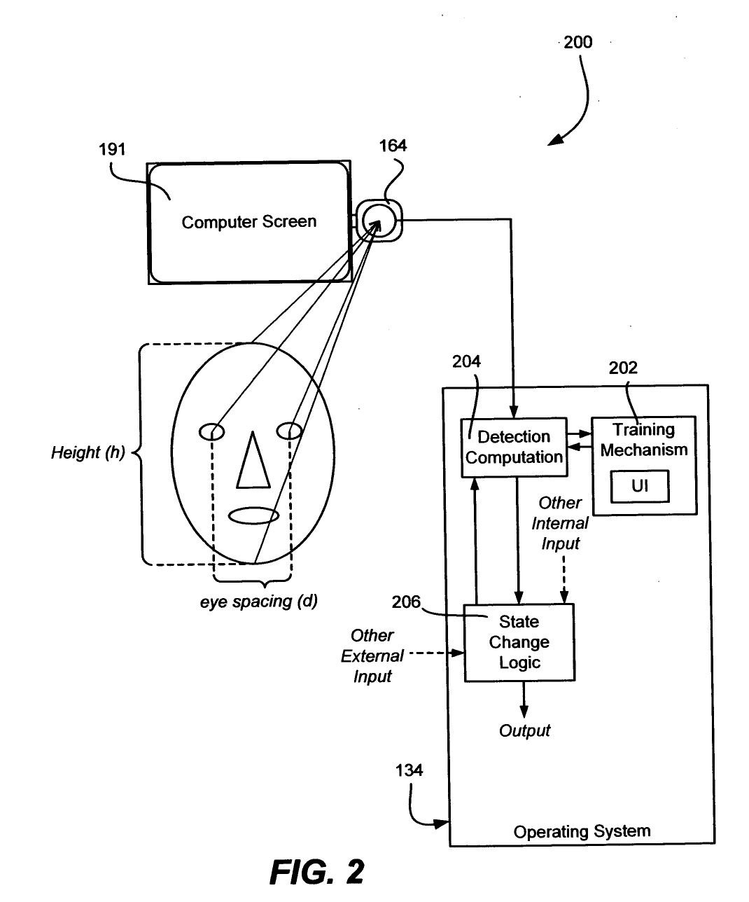

FIG. 2 is a general representation of a computer-camera detected face and certain measured characteristics thereof, useful in detecting visual cues that are processed in accordance with various aspects of the present invention;

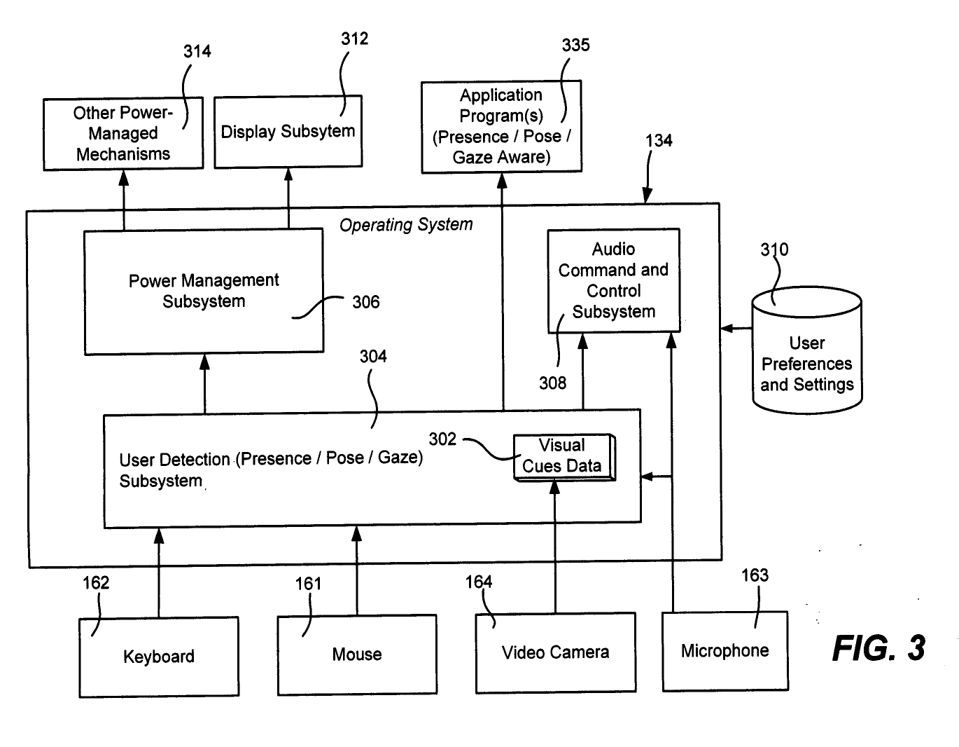

FIG. 3 is a block diagram generally representing programs and components for selectively controlling computer system state based on visual cues, in accordance with various aspects of the present invention;

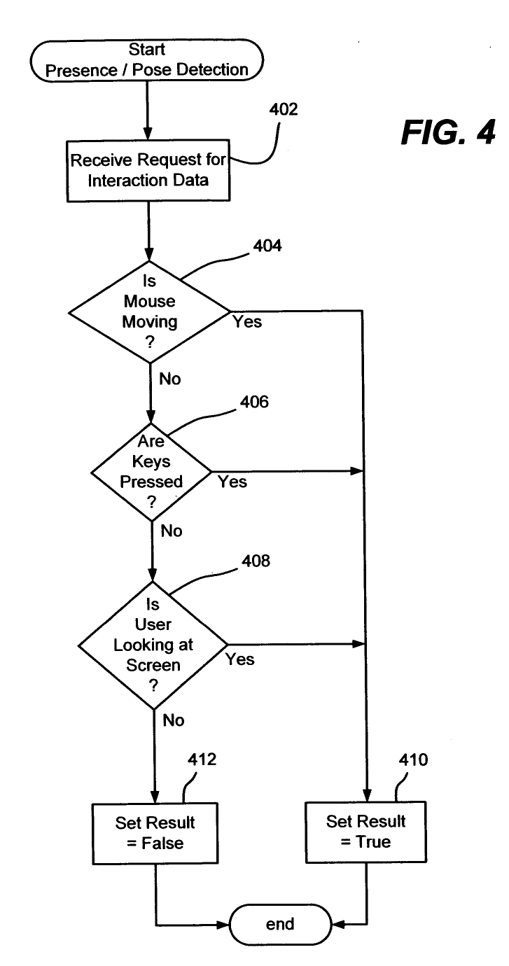

FIG. 4 is a flow diagram representing example logic that may be used to determine whether and/or how to change one or more computer operating states based on user behavior including visual cues, in accordance with various aspects of the present invention;

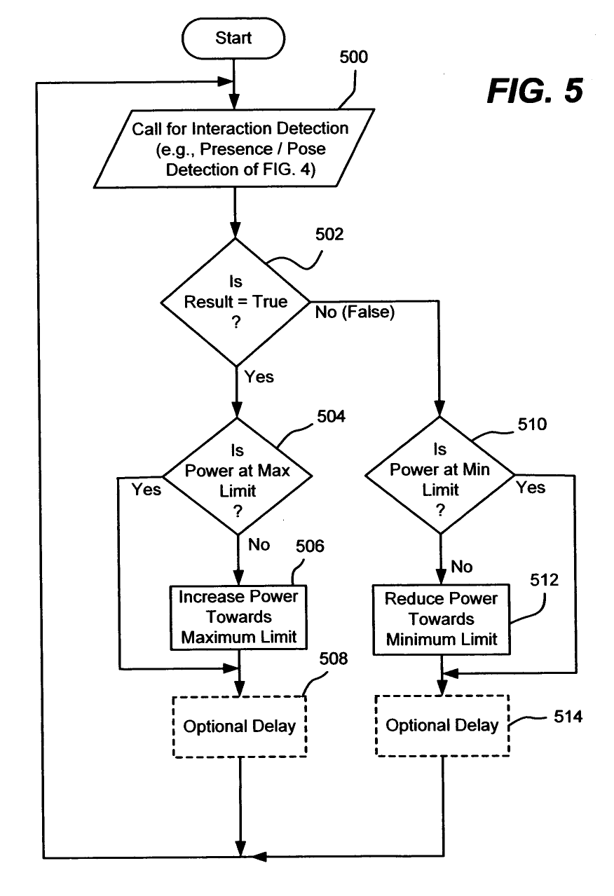

FIG. 5 is a flow diagram representing example logic that may be used to determine whether and/or how to change resources' power states based on user behavior including visual cues, in accordance with various aspects of the present invention;

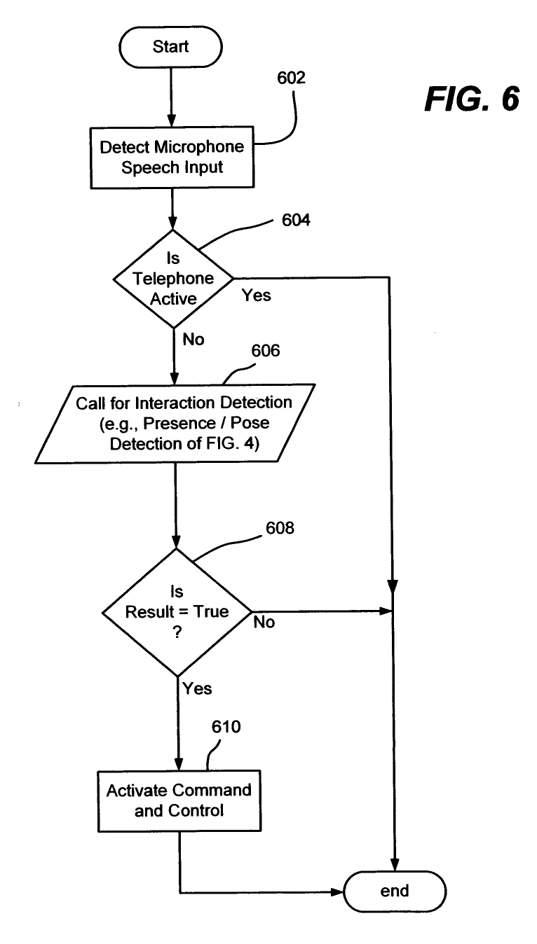

FIG. 6 is a flow diagram representing example logic that may be used to determine whether and/or how to change a speech recognition state based on user behavior including visual cues and other example criteria, in accordance with various aspects of the present invention; and

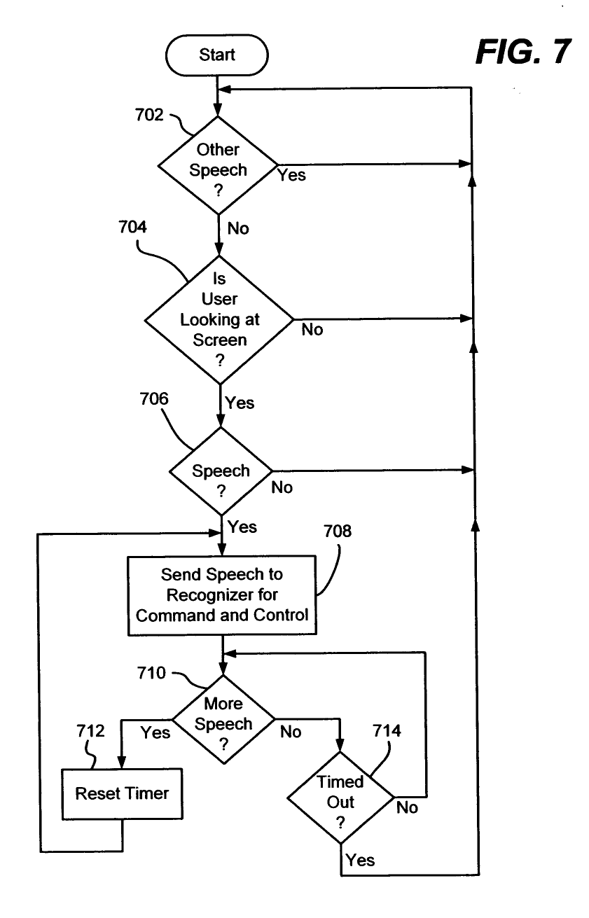

FIG. 7 is a flow diagram representing example logic that may be used to process speech when directed towards a computer system, in accordance with various aspects of the present invention.

### DETAILED DESCRIPTION

Exemplary Operating Environment

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 110 through input devices such as a tablet or electronic digitizer, a microphone 163, a keyboard 162 and pointing device 161, commonly referred to as mouse, trackball or touch pad. A user may also input video data via a camera 164. Other input devices not shown in FIG. 1 may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as speakers 195 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

State Changes Based on Detected Visual Cues

The present invention is generally directed towards a system and method by which a computer system is controlled based on detected visual cues. The visual cues establish whether a user is present at a computer system, is physically looking at something (typically the computer's system's display) indicative of intended user interaction with the computer system, and/or is looking at a more specific location. As will be understood, numerous ways to implement the present invention are feasible, and only some of the alternatives are described herein. For example, the present invention is highly advantageous with respect to reducing power consumption, as well as with activating/deactivating speech recognition, however many other uses are feasible, and may be left up to specific application programs.

As will be understood, for obtaining visual cues, the present invention leverages existing video-based presence detection, pose detection and/or gaze detection technology to determine a user's intent with respect to interaction with a computer system. Thus, the examples set forth herein are representative of current ways to implement the present invention, each of which will continue to provide utility as these technologies evolve. As such, the present invention is not limited to any particular examples used herein, but rather may be used various ways that provide benefits and advantages in computing in general.

FIG. 2 shows an example environment 200 for recognizing a user's presence as well as a current facial orientation pose. Note that facial analysis, already employed for pose detection and other purposes, may be used to detect a user's presence, however the user's presence may be determined by analyzing other data, such as motion in the video. Thus, with respect to presence detection, it is understood that other video-based presence detection techniques as well as other techniques (e.g., infrared heat sensors, proximity sensors, motions sensors and so forth) may be employed without departing from the scope of the present invention.

Moreover, FIG. 2 provides a simplified example of pose detection based on the user's relative eye spacing relative to height of head. However, it is understood that other software-based mechanisms for determining facial presence and/or orientation besides the use of eye spacing are feasible. For example, the technology described in the aforementioned U.S. Patent applications, Ser. Nos. 10/621,260 and 10/154,892 may be employed for obtaining visual cues. Such alternative mechanisms may be used instead of eye spacing, or utilized in combination with eye spacing, as well as with each other to improve the accuracy of the presence and orientation detection system. For example, the aspect ratio of a bounding box of a user's head in the video image may be used with a face detector/tracker that is pre-trained with a large number of face images under different poses and illumination conditions. A face detector/tracker that is trained with the image of a particular user also may be employed.

In one implementation, an eye-spacing algorithm may be employed. Such an eye-spacing algorithm may be generic to apply to many users, or trained via a training mechanism 202 (e.g., of the operating system 134) for a particular user's face. For example, training may occur by having the user position his or her face in a typical location in front of a display during usage, and commanding a detection computation mechanism 204 through a suitable user interface (UI) to learn the face's characteristics. The user may be instructed to turn his or her head to the maximum angles that should be considered looking at the display 191, in order to train the detection computation mechanism 204 with suitable angular limits. Note that the examples described herein describe angles relative to the center of the display 191, rather than to the camera 164, although a user can set whatever point is desired as the center, and may set any suitable limits. Further, note that the position of the eyes within a facial image is detectable, and thus spacing measured in any number of ways, including by blink detection, by detection of the pupils via contrast, by “red-eye” detection based on reflection, and so forth.

Once the facial image is captured and learned, the eye spacing (d) is measured relative to the head height (h), e.g., (d)/(h). As represented in FIG. 2, this allows eye spacing to be normalized by the detection computation mechanism 204 relative to the distance of the face to the camera 164, because eye separation not only changes as the head turns, but also changes as the user moves towards or away from the camera 164. The maximum normalized eye spacing may be averaged over time to represent the face at zero degree viewing of the camera 164. For cameras that are not centered relative to the display, such as in FIG. 2, an offset adjustment may be calibrated and/or calculated for the user based on the position of the camera 164 relative to the display 191, so that a user looking straight ahead at the display 191 rather than at the camera 164 may be considered at zero degrees.

Whenever the user's head turns beyond a certain angle off-center relative to the display screen, which may be user-calibrated as described above, then the currently measured and normalized eye spacing value indicates to the detection computation mechanism 202 that the user's face is no longer positioned so as to be looking at the display 191. Note that by sampling at a rate that is faster than a user's head can turn, or by using other facial characteristics, it is known whether the user has turned left or right. This is useful for non-centered cameras as in FIG. 2, because the normalized eye spacing otherwise would have an equal value when looking at the display 191 or to an equivalent point relative to the display that is opposite the camera.

Thus, in the example of FIG. 2 where the camera 164 is to the right of the display monitor 191, a user looking directly at the camera 164 will have the maximum eye spacing value, prior to any applied offset. As a result, after applying the offset in this example, the measured maximum (d) will not correspond to zero degrees to the display, but will be some number N degrees right of the display. If the user turns right, this number will increase. If the user turns left, back towards the center of the display 191, the use will move towards zero degrees, until the center is passed, where the angle value will start increasing towards the left.

In actual operation (following training), an event or the like indicative of whether the user is looking towards the display 191 or away from it may be output by the detection computation mechanism 204, such as whenever a transition is detected, for consumption by state change logic 206. Alternatively, the state change logic 206 may poll for position information, which has the advantage of not having to use processing power for facial processing (e.g., pose detection) except when actually needed. Note that for purposes of simplicity herein, one alternative aspect of the present invention is in part described via a polling model that obtains a True versus False result. However it is understood that any way of obtaining the information is feasible, including that the detection computation mechanism 204 may use the information itself to take action, e.g., the detection computation mechanism 204 may incorporate the state change logic 206. Further, the detection computation mechanism 204 may use or return an actual (e.g., offset-adjusted) degree value, possibly signed or the like to indicate left or right, so that for example, different decisions may be made based on certainty of looking away versus looking towards, that is, not simply True versus False, but a finer-grained decision.

As described below, other criteria may be used to assist the state change logic 206 in making its decision, including user settings for example, or other operating system internal (e.g., time-of-day) input data and/or external data (e.g., whether the user is using a telephone). For example, input information such as mouse or keyboard-based input also indicate that a user is interacting with the computer system, and may thus supplant the need for pose detection, or enhance the pose detection data in the state change logic's decision making process.

FIG. 3 is a block diagram representing various hardware and software components in one example implementation of the present invention. In general, the operating system 134 discovers that a video camera 164 is connected, and utilizes this camera 164 to obtain visual cues data 302, and thereby process an image of the user's face, using software techniques such as those generally described above and/or with reference to FIG. 2. To this end, a user detection (presence, pose and/or gaze) subsystem 304 is provided, which may also detect other input such as keyboard and mouse input, and speech input by the user. As described above, various algorithms in the user detection subsystem 304 may be employed to determine the presence and likely interaction intentions of the user, including those that operate on visual cues by analyzing the user's face and the orientation of the face relative to display, as well as by detecting key presses, mouse movements and/or speech. As described below, this information may be used in various ways to represent user presence, pose and/or gaze to other component parts of the computer system, including presence, pose and/or gaze-aware applications 335.

FIG. 4 is an example of logic that may be used to determine whether a user is interacting with a computer system, whether physically and/or visually by looking at the display. Note that FIG. 4 is a poll model, where a request is received at step 402 before possible interaction is evaluated. However, FIG. 4 may be effectively used as event-based model, by having the request being an inherent part of a continuous or occasional loop that sends an event, such as on a transition from False to True (or vice-versa), rather than returning a True or False result to a caller.

To determine interaction, step 404 evaluates whether there is detected mouse movement, while step 406 evaluates whether the keyboard is being used. Note that such mechanisms currently exist today for screensaver control/power management, and may include timing considerations, e.g., whether the mouse is moving or has moved in the last N seconds, so that movement at the exact instant of evaluation is not required. In this simplified example, if mouse movement or keyboard usage is detected at steps 404 or 406, respectively, then the result is True at step 410, that is, the user is interacting with the computer system.

In accordance with an aspect of the present invention, if the user is not physically interacting at steps 404 or 406, step 408 is executed to determine whether the user is looking at the screen. As described above, visual cues are used in this determination. If so, the result is True at step 410, otherwise the not, the result is False at step 412. Note that speech detection may likewise be including as a test for interaction, however as described below with reference to FIGS. 6 and 7, speech may have different meanings depending on whether the user is interacting with the computer system or not, and thus has been omitted from the example of FIG. 4. Further, note that while these evaluations may be done in any order, it is generally desirable to exit such a test while consuming the least amount of processing power; for example, by processing visual cues only if and when mouse detection and/or keyboard detection fails, there often is no need to process visual cues, saving processing power.

Returning to FIG. 3, two primary examples of use of presence, pose and/or gaze information described herein include power management and management of a voice recognition-based command and control subsystem. In general, a power management subsystem 306 uses the presence, pose and/or gaze information to control power consumption by various computer resources, e.g., the display subsystem 312, while an audio command and control subsystem 308 uses the presence, pose and/or gaze information to activate or deactivate voice recognition for command and control. Other examples include operating system and/or application-specific uses such as operating differently depending on whether and/or where a user is looking, e.g., changing focus between programs, adjusting zoom based on distance, and so forth.

Turning to power management, it is well known that with current mobile computing technology, a significant power consumer is the display subsystem 312, including the LCD screen, backlight, and associated electronics, consuming on the order of up to forty percent of the power, and thereby being a major limiting factor of battery life. Thus, power conservation is particularly valuable in preserving battery life on mobile devices. However, power management also provides benefits with non-battery powered computer systems, including cost and environmental benefits resulting from conservation of electricity, prolonged display life, and so forth.

Contemporary operating systems attempt to ascertain user presence by the delay between keyboard or mouse presses, and attempt to save power by turning off the display when the user is deemed not present. However, the use of keyboard and mouse activity is a very unreliable method of detecting presence, often resulting in the display being turned off while a person is reading (e.g., an email message) but not physically interacting with an input device, or conversely resulting in the display being left on while the user is not even viewing it.

In accordance with an aspect of the present invention, there is provided a generalized method of managing power based on visual cues, by detecting user presence, pose and/or gaze. Visual cues are used to reduce power consumption, as well as improve the user's power-related computing experience by more intelligently controlling display power or other resource power. This may be accomplished in any number of ways, including modes that are configurable by the user's preferences and settings 310.

As one example of usage, whenever a user looks away from the display, the detection subsystem can dim or blank the screen by providing information to the display subsystem 312, to progressively dim the screen to completely blank or some other minimum limit. Similarly, other powered-managed mechanisms as represented in FIG. 3 by the block 314 may be controlled, e.g., the processor speed may be reduced, disks may be spun down, network adapters disabled, and so forth. The data corresponding to the user's current visual cues may be event-based, or based on periodic polling by the power management subsystem 306. Other criterion may factor into the decision of what action to take.

For example, the presence of a user that is neither typing nor moving the mouse/pointer (and possibly not interacting by speaking into the microphone) may be used as input, in conjunction with visual cues that indicate the user is not looking at the display, to turn off the display or fade the display to a lower-power setting. This information may also be used to control other power-managed mechanisms 314, such as to slow the processor speed, and so forth.

Other modes are possible. For example, when visual cues indicate that a user is not looking but is otherwise still interacting, e.g., typing, a mode may be triggered in which the display may be slowly dimmed to some lowered-level, but no other action taken, which works well with users that are touch (sight) typists that look at the data to enter rather than the display, perhaps glancing occasionally at the display. In another possible mode, looking at the display while there is an open program window may be used to assume the user is reading, and thus in such a situation the lack of keyboard and mouse interaction may not be used as criteria to turn off the display. In another mode, a user or default (e.g., maximum battery) power setting may configure a machine such that simply looking away any time may fade the display out (dim, slower refresh rate, lower color depth, change the color scheme and so on), while looking towards the display may fade the display in. Thus, depending on aggressiveness of a given mode's power settings, visual cues may do different things, including dim the display or turn the display subsystem 314 completely off or on.

FIG. 5 is a flow diagram showing example logic that may be used by a power management subsystem 306 for a simple decision as to whether to increase or reduce power based on presence and/or pose detection that determines whether a user is interacting with a computer system, e.g., via the logic of FIG. 4, as invoked via step 500.

If the result is True as evaluated at step 502, that is, the user is interacting, step 502 branches to step 504 where a determination is made as to whether the power is already at maximum power. If not, the power is increased via step 506 towards the maximum level, otherwise there is no way to increase it and step 506 is bypassed. Note that the increase may be instantaneous, however step 506 allows for a gradual increase. Step 508 represents an optional delay, so that the interaction detection need not be evaluated continuously while the user is working, but rather can be occasionally (intermittently or periodically) checked. If used, the delay at step 508 also facilitates a gradual increase in power, e.g., to fade in the display once looking has resumed, thereby avoiding a sudden flashing effect.

In the event that the result is False, that is, the user is not interacting, step 510 is executed to determine whether the power is already at the minimum limit, e.g., corresponding to a current power settings mode, such as a maximum battery mode. If not, step 512 represents reducing the power, again instantly if desired, or gradually, until some lower limit is reached (which may be mode-dependent). Note that in order to come back when the user again interacts, some interaction detection is still necessary, e.g., the mouse detection keyboard detection and camera/visual cues detection still need to be running, and thus the power management should not shut down these mechanisms, at least not until a specified (e.g., relatively long) time is reached. Step 514 represents an optional delay, (shown as possibly different from the delay of step 508, because the delay times may be different), so that the power reduction may be gradual, e.g., the display will fade out.

As mentioned above with reference to FIG. 3, another example way to use visual cues is with respect to activating and deactivating voice recognition-based command and control via an audio command and control subsystem 308. With respect to voice command and control, a significant challenge heretofore has been determining whether the user is intending to speak to the computer, or is simply talking. Contemporary solutions require the user to us a physical actuator, such as pressing and releasing a button, or a voice cue, such as speaking a “name” of the device; both of these mechanisms can be unnatural for the user.

In keeping with the present invention, by using visual cues such as pose detection or gaze detection data, a differentiation may be made between a user that is directing speech towards a computer or is directing speech elsewhere, such as towards someone in the room. In general, if the user is looking directly at the computer it is likely that the user wants to command the device, and thus speech input should be accepted for command and control. Note that speech recognition for dictating to application programs may use visual cues in a similar manner, however when dictating a particular dictation window (e.g., an application window) is open and thus at least this additional information is available for making a decision. In contrast, command and control speech may occur unpredictably and/or at essentially any time.

FIG. 6 shows one possible example of logic used in determining whether speech is directed towards command and control, or elsewhere. In FIG. 6, rather than looping waiting for a user to look at the computer screen, which consumes processing power when the computer system is active, step 602 represents triggering the logic when speech or suitable sound (as opposed to simply any sound) is detected at the microphone. Note that microphone array technology can pinpoint the direction a voice is coming from, and/or visual cues can detect mouth movement, whereby a determination may be made as to whether the person that is currently speaking is the same user that is looking at a computer system display.

Step 604 represents determining whether the user is speaking on the telephone. For example, some contemporary computers know when landline or mobile telephones are cradled/active or not, and computer systems that use voice over internet protocol (VOIP) will know whether a connection is active (the same microphone may be used); a ring signal picked up at the microphone followed by a user's traditional answer (e.g., “Hello”) is another way to detect at least incoming calls. Although not necessary to the present invention, detection of phone activity is used herein as an example of an additional criterion that may be evaluated to help in the decision-making process. Other criterion, including sensing a manual control button or the like, recognizing that a dictation or messenger-type program is already active and is using the microphone, and/or detecting a voice cue corresponding to a recognized code word, may be similarly used in the overall decision-making process.

In FIG. 6, if speech is detected at step 602 and (to the extent known) the user is not talking on the telephone at step 604, step 606 is executed, representing a call to FIG. 4 to determine whether the user is currently interacting with the computer system. As described above, this may be decided by detection of the user using the mouse or keyboard, or by the user looking at the display, any of which indicate the user is actively interacting with the computer system. For many users, this would indicate speech is directed towards the computer system. Alternatively, this may be somewhat undesirable for other users, because some users may type and/or use the mouse while speaking to others. In such a situation, only visual cues are evaluated to decide. Thus, certain tests for active interaction may be bypassed depending on desired modes, which may be based upon user-configured preferences and settings 310. In any event, the present invention provides the ability to process speech as input based on the fact that the user is looking at the device, as either the sole indicator or in conjunction with other criteria.

If the user is interacting, step 608 branches to step 610 where command and control is activated. Although not shown in FIG. 6, deactivation may be accomplished via a time-out counter following end of speech, and/or by user presence data indicating the user is no longer present. The time-out counter may be adjusted based on whether the user is currently looking at the display (e.g., a longer timeout) or not (a shorter timeout).

FIG. 7 shows an alternative example, where, for example the computer is waiting for the user to direct speech to the device. In this example, rather than waiting for a speech event to trigger operation as in FIG. 6, the process runs awaiting speech. However, step 702 first evaluates whether it is known that the user is not directing speech to the command and control subsystem 308, but is using speech for other purposes, e.g., the telephone is active or the user is running a program that is using the microphone for other purposes, such as for a dictation program or a messenger-type program configured for voice conversation. Note that exceptions such as these are only one example type of criteria, and can be overridden by other criteria such as events indicative of other exceptions. For example, if a notification pops up during a pause in a telephone conversation, and the user then looks at the display and suddenly speaks after having not previously been directly looking at the display, it is somewhat likely that the user is directing speech to the personal computer.

If not known to be using speech for other purposes, step 702 branches to step 704 where pose (or gaze) detection is used to determine whether the user is looking at the display screen. If not, step 704 branches back to step 702 and the process continues waiting, by looping in this example. Note that although processing visual cues consumes resources, the logic of FIG. 7 is useful in situations where the computer is essentially idle, waiting for the user to give a command.

If at step 704 the user is looking at the screen, step 706 is executed to determine whether the user has begun speaking. If not, the process branches back to loop again. As can be readily appreciated, steps 702, 704 and 706 are essentially waiting for the user to speak what is likely to be a command to the screen. When this set of conditions occurs, step 706 branches to step 708, which sends the speech as data to a speech recognizer for command and control purposes.

Note that depending on the speech command, the command and control may end the process of FIG. 7, e.g., “shut down the computer system,” or “run” some particular program that takes over the microphone, whereby command and control is deactivated. However, for purposes of the present example, consider that the command does not end command and control, and that the user may or may not continue speaking, e.g., to finish a part of a command or speak another one.

Step 710 represents detecting for such further speech, which if detected, resets a timer at step 712 and returns to step 708 to send the further speech to the speech recognizer. If no further speech is detected within the timer's measured time as evaluated at step 714, the process returns to step 702 to again wait for further speech with a full set of conditions required, including whether the visual cues detected indicate that the user is looking at the computer screen while speaking. Note that the time out a step 714 may be relatively short, to allow the user to briefly and naturally pause while speaking (by returning to step 710), without requiring visual cue processing and/or require that the user look at the screen the entire time he or she is entering (a possibly lengthy set of) verbal commands.

In this manner, various tasks such as power management and speech recognition are improved via presence detection and/or pose detection. As can be readily appreciated, gaze detection can further improve the handling of computer tasks.

For example, U.S. patent application Ser. No. 10/985,478 describes OLED technology in which individual LEDs can be controlled for brightness; gaze detection can conserve power, such as in conjunction with a power management mode that illuminates only the area of the screen that the user is looking at. Gaze detection can also move relevant data on the display screen. For example, auxiliary information may be displayed on the main display, while other information is turned off. The auxiliary information can move around with the user's eye movements via gaze detection. Gaze detection can also be used to launch applications, change focus, and so forth.

For use with speech recognition, gaze detection can be used to differentiate among various programs to which speech is directed, e.g., to a dictation program, or to a command and control program depending on where on the display the user is currently looking. Not only may this prevent one program from improperly sensing speech directed towards another program, but gaze detection may improve recognition accuracy, in that the lexicon of available commands may be narrowed according to the location at which the user is looking. For example, if a user is looking at a media player program, commands such as “Play” or “Rewind” may be allowed, while commands such as “Run” would not.

As can be seen from the foregoing detailed description, there is provided a system and mechanism that leverage the visual detection capabilities of a computer camera to improve a user's overall computing experience. Power management, speech handling and other computing tasks may be improved based on visual cues. The present invention thus provides numerous benefits and advantages needed in contemporary computing.

While the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention.

What is claimed is:

1. In a computer system, a method comprising:
determining whether the user is looking in a predetermined direction based on visual cue data received from a computer camera; and
changing at least one non-camera computer operating state based upon where the user is looking.

2. The method of claim 1 wherein determining whether the user is looking comprises processing the visual cue data for pose detection via a user detection subsystem.

3. The method of claim 1 wherein determining whether the user is looking comprises processing the visual cue data for gaze detection via a user detection subsystem.

4. The method of claim 1 wherein the predetermined direction corresponds to looking at a display of the computer system, and wherein changing at least one non-camera computer operating state based upon whether the user is looking at the display comprises managing power to reduce power consumption when the user is not looking at the display.

5. The method of claim 4 wherein managing power to reduce power consumption comprises controlling a display subsystem to reduce power consumed by the display subsystem when the user is not looking at the display.

6. The method of claim 1 wherein the predetermined direction corresponds to looking at a display of the computer system, and wherein changing at least one non-camera computer operating state based upon whether the user is looking at the display comprises, decreasing brightness of at least one visible area on the display when the user is not looking at the display, and increasing brightness of at least one visible area on the display when the user is looking at the display.

7. The method of claim 1 wherein changing at least one computer operating state based upon whether the user is looking in the predetermined direction comprises sending speech to a speech recognizer when the user is looking in the predetermined direction, and not sending speech to the speech recognizer when not looking.

8. The method of claim 1 wherein determining whether the user is looking in a predetermined direction is performed after determining that the user is not physically interacting with the computer system.

9. The method of claim 1 wherein changing at least one non-camera computer operating state based upon whether the user is looking comprises changing a state based on user preference and settings data.

10. The method of claim 1 wherein determining whether the user is looking in the predetermined direction comprises receiving information corresponding to gaze detection data.

11. At least one computer-readable medium having computer-executable instructions, which when executed perform the method of claim 1.

12. In a computer system, a subsystem comprising:
means for determining whether the user is interacting with the computer system, including computer camera means for determining whether the user is looking in a predetermined direction corresponding to the computer system; and
means for changing at least one non-camera computer operating state based upon whether the user is looking in the predetermined direction.

13. The subsystem of claim 12 wherein the means for determining whether the user is interacting with the computer system further includes means for detecting input from a set of at least one physical input device, the set containing a pointing device, a keyboard and a microphone.

14. The subsystem of claim 11 wherein the means for changing at least one non-camera computer operating state comprises power management means.

15. The subsystem of claim 11 wherein the means for changing at least one non-camera computer operating state comprises speech processing means.

16. At least one computer-readable medium having computer-executable instructions, which when executed perform steps, comprising:
receiving visual cues from a computer camera;
determining based on the visual cues whether a computer system user is looking in a predetermined direction;
providing information indicative of whether the user is looking in the predetermined direction; and
changing a non-camera computer operating state based upon the information.

17. The computer-readable medium of claim 16 wherein providing the information comprises communicating data to a power management subsystem, and wherein changing the non-camera computer operating state based upon the information comprises adjusting power consumption corresponding to at least one computer system resource.

18. The computer-readable medium of claim 17 wherein the predetermined direction corresponds to the direction of a display, and wherein adjusting power consumption corresponding to at least one computer system resource comprises reducing power consumed by the display when the information indicates that the user is not looking at the display.

19. The computer-readable medium of claim 16 wherein providing the information comprises communicating data to an audio subsystem that handles speech input, and wherein changing the non-camera computer operating state comprises activating and deactivating speech recognition based upon the information.

20. The computer-readable medium of claim 19 further comprising receiving speech input, wherein the predetermined direction corresponds to the direction of a display, and wherein activating speech recognition comprises sending speech data for speech processing when the information indicates that the user is looking at the display.
